(19) United States
(12) Patent Application Publication
(10) Pub. No.: US 2019/0130671 A1
(43) Pub. Date: May 2, 2019

(54) Vehicle Documentation System with Dynamic Setting Controls

(71) Applicant: ADESA, Inc., Carmel, IN (US)

(72) Inventors: Christopher Dillow, Carmel, IN (US); James Michael Irish, San Diego, CA (US)

(73) Assignee: ADESA, Inc., Carmel, IN (US)

(21) Appl. No.: 16/219,307

(22) Filed: Dec. 13, 2018

Related U.S. Application Data
(63) Continuation-in-part of application No. 14/477,615, filed on Sep. 4, 2014.

(51) Int. Cl. G07C 5/08; G06K 9/00; B64C 39/02

(52) U.S. Cl. CPC G07C 5/0841; B64C 2201/127; B64C 39/024; G06K 9/00671

(57) ABSTRACT

A vehicle documentation system uses multiple sensor systems to capture vehicle information and generate vehicle documentation. A sensor system may measure and or adjust settings, such as light settings or position settings, dynamically within an enclosed area surrounding a vehicle. The settings may be adjusted based on vehicle information obtained from a vehicle report describing vehicle history and vehicle build information.

### CROSS REFERENCE TO RELATED APPLICATION

This application is a continuation in part of U.S. patent application Ser. No. 14/477,615, filed on Sep. 4, 2014, the entirety of which is hereby incorporated by reference herein.

### TECHNICAL FIELD

This disclosure relates to a vehicle documentation system that uses multiple sensor systems to capture vehicle information and generate vehicle documentation.

### BACKGROUND

With rapid advances in network connectivity, the landscape for sale of items at auctions, such as sale of vehicles at auctions has also changed. For example, in the past, potential bidders at vehicle auctions physically inspected a vehicle prior to valuating the vehicle and determining whether to place a bid and/or what bid to place for the vehicle.

More recently, potential bidders have adopted reviewing information about the auction-items electronically, such as through a website, over the Internet or other network connection having computer or other display equipment. For example, potential bidders on a vehicle may review documentation, including mechanical details, history, accident reports, and other information along with images of the vehicle, on their computer or other display equipment connected to the network.

Although advances in network connectivity allow potential bidders to review documentation remotely from their computer, the merchants placing their vehicles for sale are still manually taking pictures of their vehicles and uploading the documentation to servers for the potential bidders to access without any specific knowledge of the vehicle's history.

### BRIEF DESCRIPTION OF THE DRAWINGS

FIG. 1 shows an exemplary vehicle documentation system.

FIG. 2 shows an exemplary booth controller device.

FIG. 3 shows an exemplary sensor system.

FIG. 4 shows an exemplary method performed by a sensor system in a vehicle documentation system.

FIG. 5 shows exemplary commands transmitted in a vehicle documentation system.

FIG. 6 shows an exemplary vehicle documentation booth.

FIG. 7 shows an exemplary vehicle documentation generation method.

FIG. 8 shows an exemplary computer system for a computing device included in the vehicle documentation system shown in FIG. 1.

FIG. 9 shows an exemplary graphical user interface for the vehicle documentation system.

### DETAILED DESCRIPTION

The discussion below makes reference to a vehicle documentation booth to capture sensor data, such as images, of a vehicle. The vehicle documentation booth includes processing components configured to control image capturing components to capture vehicle images based on sensor data inputs received from sensors, where the sensors are configured to track characteristics of the vehicle while the vehicle is within the vehicle documentation booth. The vehicle documentation booth may be used for any documentation purpose, and may be particularly geared towards capturing vehicle images used in marketing, sales, or auction material for a vehicle.

In particular, the vehicle documentation booth may be controlled to capture vehicles images that include a depiction of vehicle identification information such as the vehicle license plate, vehicle identification number (VIN), or other vehicle identification marking found on the vehicle. The vehicle identification information may be extracted from the captured vehicle images to locate a vehicle report corresponding to the vehicle, and the vehicle report may be referenced to generate a vehicle inspection form that includes instructions and other information tailored for the vehicle based on the vehicle report. The vehicle documentation booth may further analyze information from the vehicle report to tailor an inspection protocol based on the analyzed information, including the operational control of components to abide by the tailored protocol. The tailored protocol may include controlling image capturing devices to reposition themselves within the vehicle documentation booth, and/or recalibrate settings of the image capturing devices, to capture images of the vehicle based on vehicle-specific information obtained from the vehicle report.

To capture the vehicle images, the vehicle documentation booth may be equipped with multiple sensor systems distributed within the booth structure, such as light-intensity sensors, vehicle position sensors, cameras, and dimmable lights. The sensors, lights, and other aspects of the vehicle documentation booth may be controlled by a control device, such as a handheld tablet computer, smartphone, desktop computer, or any other such computing device. The control device may receive data from the sensor systems, and in response to receiving the data, the control device may send instructions to some or all sensor systems in the vehicle documentation booth.

For example, the control device may adjust calibration settings such as intensity of the lights, request a particular camera to capture an image of the vehicle, control a particular camera to adjust certain camera control features to capture an image of the vehicle, control placement of a particular camera to capture an image of the vehicle, store a captured image at a particular location on a storage device, and may populate a website with information associated with the vehicle. The control device may be equipped with sensor systems of its own. For example, the control device may be equipped with a camera used to capture additional images of the vehicle, such as interior images of the vehicle. The images captured by the multiple cameras and the control device may be compiled together to create a collection of images used for marketing material for the vehicle. The control device may use a unique identifier of the vehicle, such as a Vehicle Identification Number (VIN) of the vehicle to associate the captured images and other information for future use with the vehicle documentation. The VIN corresponding to the vehicle may be obtained by image recognition of the VIN from one or more of the captured vehicle images. As discussed in more detail below, the vehicle image of the VIN may be captured by a camera on the control device and/or may be captured by a camera installed on an unmanned aerial vehicle.

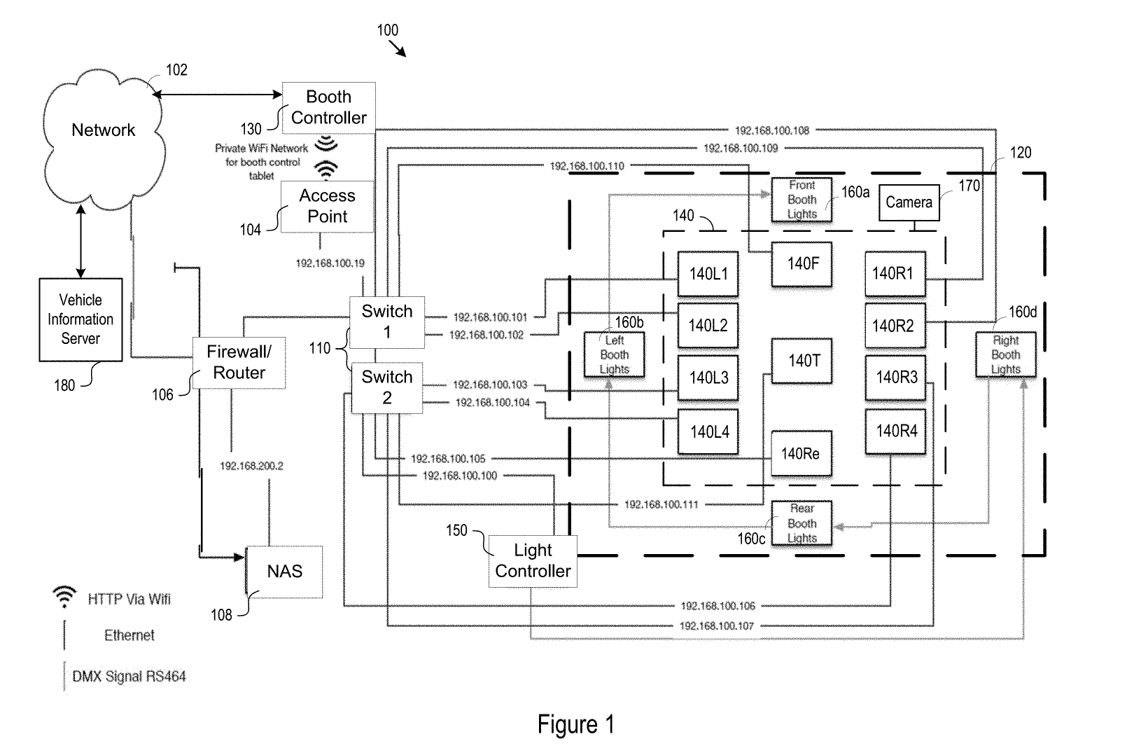

FIG. 1 shows an example vehicle documentation system 100 (the “system”). The system 100 may include several network devices which interface with a network 102. The network devices may include an access point 104, a firewall/router device 106, a network attached storage device (NAS) 108, and network switches 110. The system 100 may further include a vehicle documentation booth 120, a vehicle documentation booth controller 130, sensor systems 140, a light controller 150, and several lights 160a-d. The vehicle documentation system 100 may include other devices than those noted above.

The structure of the vehicle documentation booth 120 may be designed to be installed and withstand any selected environmental conditions where it is used, such as the conditions in place at a car dealership, storage lot, auction facility, or other location. As one example, the vehicle documentation booth 120 may be built from abrasion-proof material, such as Extruded T-Slot Aluminum. The design may be modular to facilitate shipment of the vehicle documentation booth 120 as a prefabbed kit to the documentation site. The booth structure may provide mounting points for the sensor systems 140 and lights 160 and a controlled environment for consistent capture of sensor system measurements.

The lights 160a-d may be single lights or groups of lights that are placed at predetermined locations within the vehicle documentation booth 120 to serve as illumination sources. The lights may be controllable lights that provide a varying illumination output, such as 30,000 Lumen Daylight Balanced Studio Photography LED Lights. The lights may be Digital Multiplex (DMX) controlled allowing on/off and dimming capability for each light. The vehicle documentation booth 120 may include multiple lights at any predetermined locations. For example, the booth may include 16 lights, in controllable groups of four lights each at the locations indicated in FIG. 1: front booth lights 160a, left booth lights 160b, rear booth lights 160c and right booth lights 160d. The lights 160a, 160b, 160c, and 160d may be located to the front, left, rear, and right of a vehicle positioned within the vehicle documentation booth 120. However, lights may be placed individually or in groups in any pre-determined locations within the vehicle documentation booth 120 to facilitate capture of an image of the vehicle from a particular position. A controlled group of lights may be defined to include any selection of the individual lights. For example, two of the lights on the right, two from the left and one from the rear may be included in a group of lights when capturing an image using a camera 170 positioned at the front of the vehicle documentation booth 120. Other groups of lights may also be configured.

Each group of lights 160a-d may include one or more lights. The intensity of a group as a whole or each individual light within the group may be adjusted. The intensity may be adjusted via commands from the booth controller 130, or the sensor systems 140 using, for example, a DMX protocol such as DMX512. Alternatively, or in addition, the DMX512 protocol commands to the lights 160 may be bridged to the booth network via a custom written web service that runs on one of the sensor systems 140.

The camera 170 may be positioned at the front of the vehicle documentation booth 120 to capture a front windshield area of the vehicle, and in particular, a front windshield area of the vehicle that overlaps with a VIN display. According to some embodiments, the camera 170 may be installed on a moveable assembly, where the movable assembly may be controlled by the booth controller 130 to position the camera 170 so that a field of view captured by the camera 170 includes the front windshield area of the vehicle that overlaps with the VIN display. Vehicle images captured by the camera 170 that depict the VIN display may be further analyzed according to image recognition techniques to extract the VIN information for the vehicle. For example, image recognition techniques may identify a series of alphanumeric shapes within the vehicle image and determine a VIN has been recognized. In particular, a computer vision (CV) library may be utilized to implement the image recognition technique on a digital image that depicts a vehicle, and more specifically, depicts a vehicle's VIN. CV libraries are libraries that include an expanding database of visual knowledge that matches shapes, colors, and other visual cues to their real-world counterparts. The CV library may further be utilized in conjunction with artificial intelligence implemented on neural networks and/or using deep learning techniques, to achieve optimized image recognition on the digital images. It follows that an application running the image recognition techniques attributable to the vehicle documentation system 100 may identify and predict objects depicted in a digital image with a high level of accuracy. The predicted objects from the digital images may include a vehicle's VIN, or other distinct vehicle components such as wheels, fenders, windshields, doors, vehicle shape, or even vehicle color. With the ability to recognize distinct vehicle components, the image recognition techniques may also be able to recognize when damage is made to such distinct vehicle components.

The network 102 may be a local area network, a wide area network, or any other network that enables communication of data between computing communication devices. Network 102 may support wireless communications. Network 102 may also support hard-wired communications, such as a telephone line or cable. Network 102 may also support the Ethernet IEEE (Institute of Electrical and Electronics Engineers) 802.3x specification. Network 102 may be the Internet and may support IP (Internet Protocol). Network 102 may be a LAN or a WAN. Network 102 may be a hotspot service provider network. Network 102 may be an intranet. Network 102 may be a GPRS (General Packet Radio Service) network. Network 102 may be any appropriate cellular data network or cell-based radio network technology. Network 102 may be an IEEE 802.11 wireless network or any suitable network or combination of networks. Although one network 102 is shown in FIG. 1, network 102 may be representative of any number of networks (of the same or different types) that may be utilized.

The network 102 may couple one or more devices that may interact with data captured and/or stored by the other components of the vehicle documentation system 100. For example, the network 102 may be coupled to a desktop computer, a laptop computer, or a mobile device such as a smart phone or tablet computer, that interacts with the data captured and/or stored by the other components of the vehicle documentation system 100. The data captured and/or stored by the other components of the vehicle documentation system 100 may be stored, for example, by the NAS 108 or by the vehicle documentation booth controller 130, or by any other device.

The NAS 108 may be a server device, such as a file server. The NAS 108 may include circuitry to store data in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. The storage medium in the NAS 108 may be setup to create large reliable data stores, for example by adopting a RAID standard such as RAID 2, RAID 5, or any other configuration. Alternatively, or in addition, the NAS 108 may be cloud data storage, provided by a third-party service provider, such as Amazon, Google, or any other data storage providers.

The firewall/router device 106 may involve circuitry and software to provide a network security system to control incoming and outgoing network traffic from the network 102 based on a rule set. The firewall/router may establish a barrier between the network 102 and what may be considered an internal network of the vehicle documentation system 100. The internal network may include the components communicable via the network created by the network access point 104. For example, the internal network may include vehicle documentation booth 120, the vehicle documentation booth controller 130, the sensor systems 140, the light controller 150, the network switches 110, and the NAS 108. The internal network may be, for example, a local area network such as an Ethernet network, and may involve wired or wireless communication. The access point 104 may be a wireless access point. The internal network may further include network devices such as the network switches 110, routers, and hubs to extend the internal network and provide the devices within the internal network a medium to communicate. The network devices may be enabled to provide Power over Ethernet (PoE), for example, the switches may be PoE switches.

The internal network enables the vehicle documentation booth controller 130 to transmit and receive data to and from the other devices such as the sensor systems 140 and light controller 150. The vehicle documentation booth controller 130, also referred to as a booth controller 130, may transmit and receive data such as network request/response and light controller request/response. The network request/response may be a web service request/response, such as using hyper-text transfer protocol (HTTP), or any other network communication protocol. The light controller request/response may use protocols such as digital multiplex (DMX) to control the lights 160a-d via the light controller 150.

The network 102 may further couple the vehicle documentation system 100 with a vehicle information server 180. The vehicle information server 180 may store vehicle information gathered for a particular vehicle into a vehicle profile. One or more vehicle profiles may then be stored in the vehicle information server 180 according to vehicle identification information that identifies respective vehicles. Vehicle identification information may be, for example, a vehicle's unique VIN, license plate number, auction identification number when the vehicle has been processed into an auction database, or other unique identifier corresponding to the vehicle.

The vehicle information gathered by the vehicle information server 180 to include into a vehicle profile may include a vehicle history report (VHR) that includes, for example, accidents reported for a vehicle. The VHR may be retrieved from a department of motor vehicles, vehicle title database, or third party reporting services. The vehicle information server 180 may further retrieve estimated value reports (EVR) on the vehicle from third party evaluation services, and include the retrieved EVR into a vehicle's vehicle profile. The EVR may describe a predicted price a client may expect to be able to resale the vehicle for, as well as an amount a client may expect to pay wholesale for the vehicle. Alternatively, or in addition, the vehicle information server 180 may retrieve make, model, vehicle build reports describing the vehicle attributes, and/or vehicle recall information obtained from a vehicle manufacturer, and include this information into a vehicle's vehicle profile. The vehicle information server 180 may further retrieve vehicle title information from a title holding entity, and include the title information into a vehicle profile. With the information gathered by the vehicle information server 180, a vehicle profile may include vehicle specifications, vehicle condition reporting (e.g., junk, salvage, total loss), vehicle title reporting, vehicle odometer readings, vehicle recall information, as well as other vehicle specific information such as evidence of past sales or past offers for sale (e.g., identifying past offers for sale on an online auction website), existing liens on the vehicle obtained from financial institutions, and vehicle accident reports obtained from police accident reports.

In one embodiment, when the booth controller 130 obtains vehicle identification information, as described by the processes described herein, the booth controller 130 may transmit a request to the vehicle information server 180, where the request includes vehicle identification information and a request for vehicle information corresponding to the vehicle identification information. For example, the booth controller 130 may control the firewall/router device 106 to transmit the request to the vehicle information server 180 through the network 102, or alternatively, control a communication interface 202 to directly transmit the request to the vehicle information server 180 through the network 102. In response to the receiving the request, the vehicle information server 180 may parse a database of vehicle profiles for the vehicle profile matching the vehicle identification information included in the request, identify the vehicle profile matching the vehicle identification information included in the request, and return the vehicle profile matching the vehicle identification information included in the request back to the booth controller 130 for further application of the vehicle profile by the booth controller 130. As one example, the vehicle profile returned to the booth controller 130 may comprise a vehicle history report unique to the vehicle identified by the vehicle identification information. Alternatively, the vehicle profile returned to the booth controller 130 may comprise general information as to the vehicle identified by the vehicle identification information (e.g., dimensions of the vehicle matching the year/make/model as indicated by the vehicle identification information).

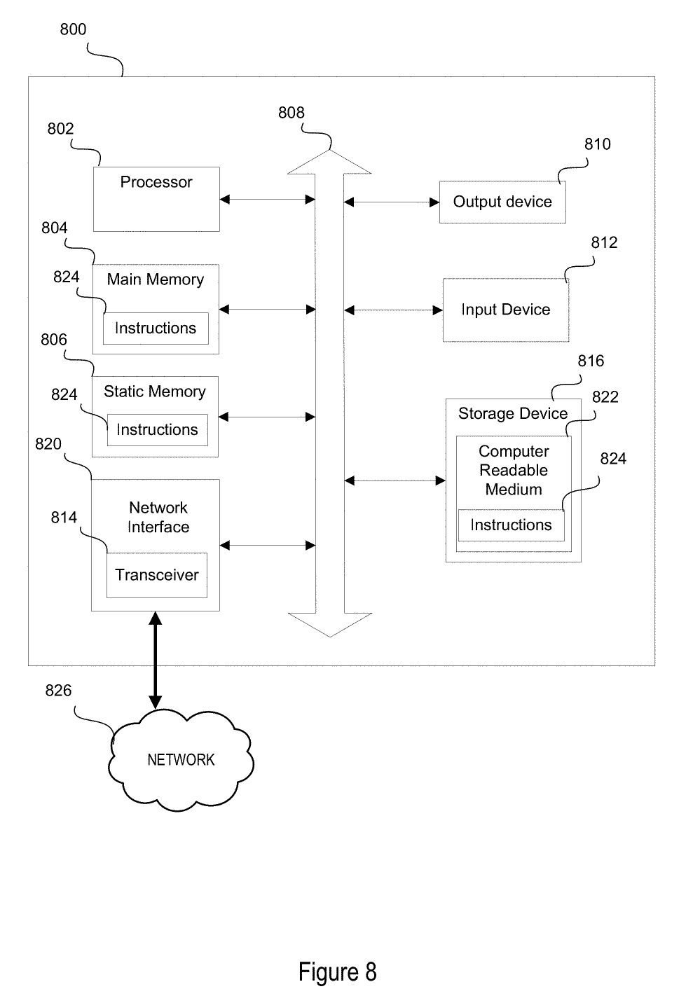

The vehicle information server 180 may be a computing device such as the computer system 800 shown in FIG. 8. FIG. 8 illustrates exemplary computer architecture for the computer system 800. Computer system 800 includes a network interface 820 that allows communication with other computers via a network 826, where network 826 may be represented by network 102 in FIG. 1. Network 826 may be any suitable network and may support any appropriate protocol suitable for communication to computer system 800. The computer system 800 may also include a processor 802, a main memory 804, a static memory 806, an output device 810 (e.g., a display or speaker), an input device 812, and a storage device 816, communicating via a bus 808.

Processor 802 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 802 executes instructions 824 stored on one or more of the main memory 804, static memory 806, or storage device 815. Processor 802 may also include portions of the computer system 800 that control the operation of the entire computer system 800. Processor 802 may also represent a controller that organizes data and program storage in memory and transfers data and other information between the various parts of the computer system 800.

Processor 802 is configured to receive input data and/or user commands through input device 812. Input device 812 may be a keyboard, mouse or other pointing device, trackball, scroll, button, touchpad, touch screen, keypad, microphone, speech recognition device, video recognition device, accelerometer, gyroscope, global positioning system (GPS) transceiver, or any other appropriate mechanism for the user to input data to computer system 800 and control operation of computer system 800. Input device 812 as illustrated in FIG. 8 may be representative of any number and type of input devices.

Processor 802 may also communicate with other computer systems via network 826 to receive instructions 824, where processor 802 may control the storage of such instructions 824 into any one or more of the main memory 804 (e.g., random access memory (RAM)), static memory 806 (e.g., read only memory (ROM)), or the storage device 816. Processor 802 may then read and execute instructions 824 from any one or more of the main memory 804, static memory 806, or storage device 816. The instructions 824 may also be stored onto any one or more of the main memory 804, static memory 806, or storage device 816 through other sources. The instructions 824 may correspond to, for example, instructions that cause the vehicle information server 180 to gather vehicle information for creating a vehicle profile.

Although computer system 800 is represented in FIG. 8 as a single processor 802 and a single bus 808, the disclosed embodiments applies equally to computer systems that may have multiple processors and to computer systems that may have multiple busses with some or all performing different functions in different ways.

Storage device 816 represents one or more mechanisms for storing data. For example, storage device 816 may include a computer readable medium 822 such as read-only memory (ROM), RAM, non-volatile storage media, optical storage media, flash memory devices, and/or other machine-readable media, or any other appropriate type of storage device. Although only one storage device 816 is shown, multiple storage devices and multiple types of storage devices may be present. Further, although computer system 800 is drawn to contain the storage device 816, it may be distributed across other computer systems that are in communication with computer system 800, such as a computer system in communication with computer system 800. For example, when computer system 800 is representative of the vehicle information server 180, storage device 816 may be distributed across to include the NAS 108 that is part of the vehicle documentation system 100.

Output device 810 is configured to present information to the user. For example, output device 810 may be a display such as a liquid crystal display (LCD), a gas or plasma-based flat-panel display, or a traditional cathode-ray tube (CRT) display or other well-known type of display in the art of computer hardware. Accordingly in some embodiments, output device 810 displays a user interface. In other embodiments, output device 810 may be a speaker configured to output audible information to the user. In still other embodiments, any combination of output devices may be represented by the output device 810.

Network interface 820 provides the computer system 800 with connectivity to the network 826 through any compatible communications protocol. Network interface 820 sends and/or receives data from the network 826 via a wireless or wired transceiver 814. Transceiver 814 may be a cellular frequency, radio frequency (RF), infrared (IR) or any of a number of known wireless or wired transmission systems capable of communicating with network 826 or other computer device having some or all of the features of computer system 800. Bus 808 may represent one or more busses, e.g., USB, PCI, ISA (Industry Standard Architecture), X-Bus, EISA (Extended Industry Standard Architecture), or any other appropriate bus and/or bridge (also called a bus controller). Network interface 820 as illustrated in FIG. 8 may be representative of a single network interface card configured to communicate with one or more different data sources.

Computer system 800 may be implemented using suitable hardware, software and/or circuitry, such as a personal computer or other electronic computing device. In addition, computer system 800 may also be a portable computer, laptop, tablet or notebook computer, PDA, pocket computer, appliance, telephone, server computer device, or mainframe computer.

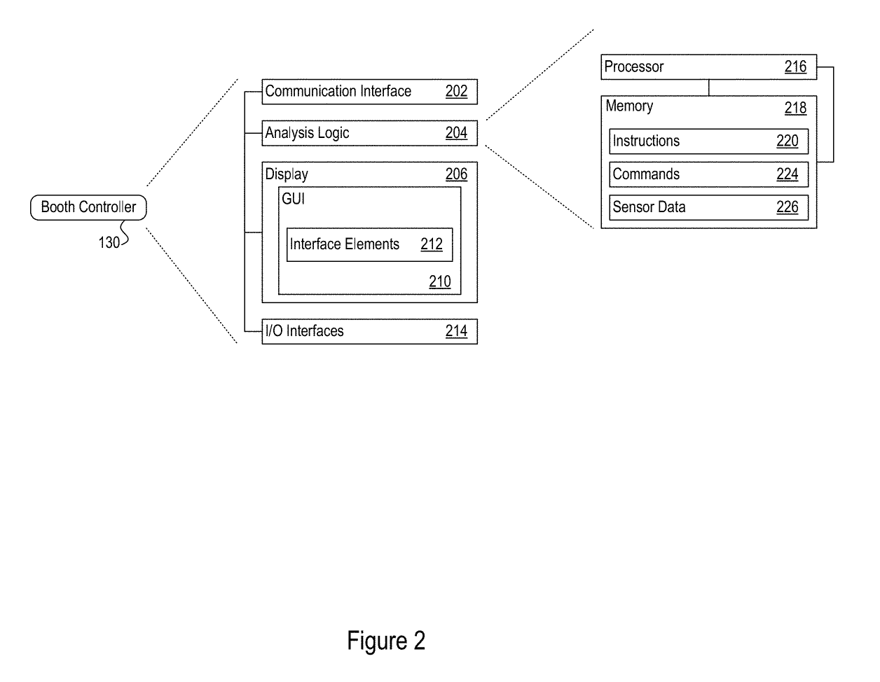

FIG. 2 shows an example booth controller 130. The booth controller 130 includes a communication interface 202, analysis logic 204, and a user interface 206. The communication interface 202 may include Universal Serial Bus (USB) interfaces, audio outputs, magnetic or optical media interfaces (e.g., a CDROM or DVD drive), network (e.g., Ethernet or cable (e.g., DOCSIS) interfaces), Serial Advanced Technology Attachment (SATA), and Peripheral Component Interconnect express (PCIe) interfaces and connectors, memory card slots or other types of serial, parallel, or network data interfaces. The communication interface 202 may include one or more Ethernet ports, or any other type of wired or wireless communication interface. For example, the communication interface 202 may include a communication interface for bi-directional communication of instructions/commands/data with the sensor systems 140, and light controller 150.

The user interface 206 may display, for example, a graphical user interface 210. The user interface 206 may display and accept user parameters, annotation commands, and display on the GUI 210 any type of vehicle documentation interface element 212. The interface element 212 may visualize, as just a few examples, images, light intensity level, or any other information or measurements captured by the sensor systems 140. The interface element 212 may also be directive interface element, such as a button, hyperlink, or any other interface element to provide a command or instruction to the system 100. For example, the interface element 212 may be an archival directive interface element that instructs one or more of the sensor systems 140 with an archival command to store captured information in the NAS 108. The user interface 206 may further present the information captured by the sensor systems 140 as an aggregated information portal, such as a web page. The captured information may be annotated with further information received from the NAS 108 or network 102, which the analysis logic 204 may request.

The input/output (I/O) interfaces 214 provide keyboard, mouse, voice recognition, touchscreen, and any other type of input mechanisms for operator interaction with the booth controller 130. Additional examples of the I/O interfaces 214 include microphones, video and still image cameras, temperature sensors, vibration sensors, rotation and orientation sensors, radiation sensors (e.g., IR or RF sensors), and other types of inputs.

The analysis logic 204 may include circuitry and software. In one implementation, the analysis logic 204 includes one or more processors 216 and memories 218. The memory 218 may store analysis instructions 220 (e.g., program instructions) for execution by the processor 216. The analysis logic 204 may include an application customized for mobile devices and operating systems, such as for Android, iOS, WebOS, Blackberry, or any other mobile device. This may allow any mobile device with the mobile application installed to effectively control the vehicle documentation system. The memory 218 may also hold the information received at the communication interface 202, such as sensor data 226 captured by the sensor systems 140. As will be described in more detail below, the analysis instructions may generate commands 224. The booth controller 130 may send the commands 224 to any network device whether within or external to the internal network. The commands 224, also referred to as requests, may cause the sensor systems 140 to be configured according to configuration instructions in the commands 224, capture information (e.g., digital images) according to information capture instructions in the commands 224, store captured information according to information storage instructions in the commands 224, and transmit captured information to the booth controller 130 according to information transmission instructions in the commands 224. The commands 224, in addition, or alternatively, may cause the lights 160a-d to change intensity. Further, the commands 224 may change the way that a network device operates, request further annotation information from the network device, or cause any other adaptation. Some examples are described further below.

The booth controller 130 may generate commands to control operation of the sensor systems 140. In an example, as in the example system 100, the sensor systems 140 may include multiple sensor systems 140F, 140T, 140Re, 140L1-L4 and 140R1-R4. Other examples may include more or less sensor systems. The sensor systems 140 may be distributed across the vehicle documentation booth 120. The sensor systems 140 may be placed at predetermined locations within the vehicle documentation booth 120. For example, the 140T sensor system, in the example system 100, may be located on a roof of the vehicle documentation booth 120 directed or oriented so as to capture sensory information of the vehicle. For example, the sensor system 140T may include a camera pointed towards the floor of the vehicle documentation booth 120 so as to capture an image of a vehicle in the vehicle documentation booth 120. The vehicle image captured by the camera included in sensor system 140T may include a depiction of the vehicle's VIN taken through the vehicle's front windshield from the overhead position.

Similarly, the sensor system 140F may be located at the front, 140Re at the rear, 140L1-L4 at the left and 140R1-R4 at right so as to capture information from the vehicle within the vehicle documentation booth 120. The sensor systems 140 are placed at predetermined locations within the vehicle documentation booth 120 so as to capture information of the vehicle from various possible angles and orientations. For example, each of the sensor system 140F, sensor system 140Re, sensor system 140L1-L4, and sensor system 140R1-R4 may include one or more cameras for capturing vehicle images, where the captured vehicle images may include a depiction of the vehicle's VIN taken through the front vehicle windshield, or other vehicle identifying information that may be included at different vehicle locations. Alternatively, the sensor systems 140 may be movable in response to commands 224 from the booth controller 130. The sensor systems 140 may be translated or rotated in one, two and/or three dimensions using servo motors, gears, extending jack plates, conveyors, or any other such movable mechanical elements. This way, the cameras that are included in the sensor systems 140 may be moved to capture vehicle images of targeted vehicle attributes (e.g., VIN information or other vehicle identification information) located at different positions on the vehicle.

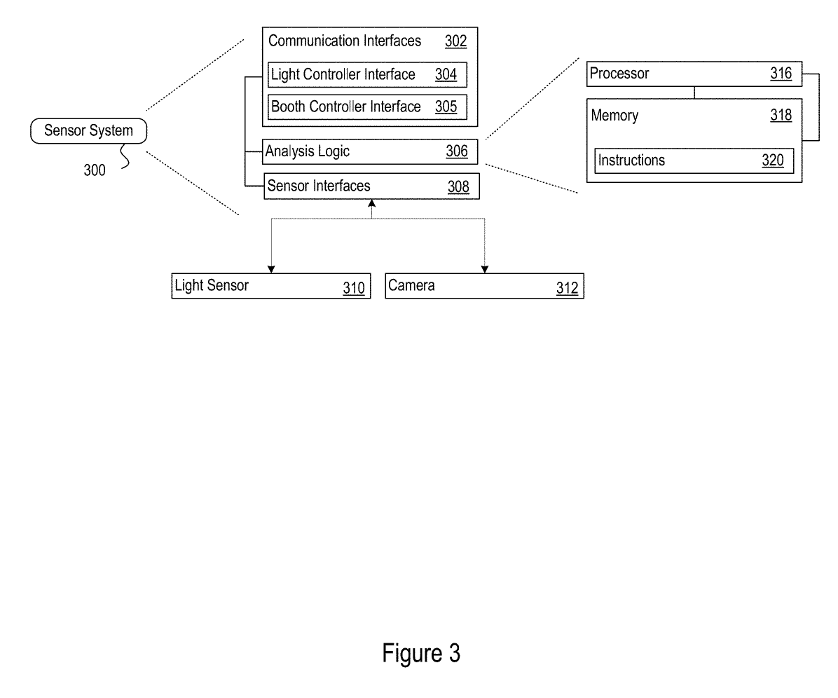

FIG. 3 shows an example sensor system 300. The sensor system 300 may be any one of the sensor systems 140. The sensor system 300 may include, among other components, communication interfaces 302, analysis logic 306, and sensor interfaces 308. The sensor system 300 may be a webserver that receives requests for data from the other network devices in the vehicle documentation system 100. The sensor system 300 may, in response, acquire the requested data and transmit it back to the requesting device. The request and response communication may occur over wired or wireless communication. The communication may use protocols such as HTTP, secure HTTP (HTTPS) or any other format.

The examples above refer to cameras in the sensor systems for capturing images. However, any sensor system may include sensors of any type. For instance, a sensor system may include an audio sensor, e.g., a microphone, a video capture device, a thermal sensor, a vibration sensor, an infrared sensor, exhaust sensors, or a sensor for any other type of measurement. Accordingly, the vehicle documentation booth 120 may capture sensor data for the vehicle across a wide variety of environmental characteristics to facilitate obtaining data to characterize the vehicle in many different ways, e.g., engine noise, or exhaust temperature and chemical composition.

For example, instead of using cameras controlled via the booth controller 130 as a central computer, the system 100 may implement a distributed architecture in which sensors, e.g., cameras, are included as part of any sensor system 300. The sensor system 300 may further include a computer system, such as a micro server, that receives instructions to capture an image from the booth controller 130. When a central computer directly communicates with the sensors, each sensor may transfer a captured image to the central computer via a protocol such as USB or 802.11 a/b/g/n/ac or the like.

In contrast, in the distributed architecture, each camera may be communicated with via a micro server. The distributed architecture facilitates control and coordination of a large collection of sensors via lightweight scripts such as Hyper Text Markup Language (HTML), JavaScript, and other combinations of scripting languages. For example, the sensor system may be a custom programmed all in one system on a chip board, such as a Raspberry PI, HummingBoard, Banana Pi, or any other system on a chip. The sensor system may operate using an operating system such as Linux, Odroid, Android, Windows RT, or any other operating system. The sensor system may be enclosed in a rugged case, such an aluminum case, to withstand the environmental conditions within the vehicle documentation booth 120. Each sensor system may be implemented as a web server, which responds to requests for images, such as web service protocol requests, or web service requests, such as HTTP requests. Instead of providing images that are stored in response to an HTTP request for an image, the sensor system may capture images using the equipped sensor, and transmit the captured image to the storage device. In addition, or alternatively, the sensor system may transmit a copy of a captured image to the requesting device. The response may be compliant with the web service request/response protocol.

FIG. 3 shows one example implementation of the sensor system 300. The communication interfaces 302 may include Universal Serial Bus (USB) interfaces, audio outputs, magnetic or optical media interfaces (e.g., a CDROM or DVD drive), network (e.g., Ethernet or cable (e.g., DOCSIS) interfaces), Serial Advanced Technology Attachment (SATA), and Peripheral Component Interconnect express (PCIe) interfaces and connectors, memory card slots or other types of serial, parallel, or network data interfaces. The communication interfaces 302 may include one or more Ethernet ports, or any other type of wired or wireless communication interface. For example, the communication interface may include a light controller interface 304 for bi-directional communication of instructions/commands/data with the light controller 150, and a booth controller interface 306 for bi-directional communication of instructions/commands/data with the booth controller 130.

The sensor interfaces 308 communicate with sensors that may be controlled by the sensor system 300. The sensors controlled by the sensor system 300 may be equipped to capture and/or measure sound, still image, video, vibration, heat, infrared light and various other physical conditions in the vehicle documentation booth 120. Examples of the sensors include microphones, video and still image cameras, temperature sensors, vibration sensors, rotation and orientation sensors, radiation sensors (e.g., IR or RF sensors), and other types of sensors. FIG. 3 illustrates the sensor interfaces 308 configured to communicate with a light sensors 310, and a camera 312 that may be controlled by the sensor system 300. For example, settings for the camera 312, such as orientation, zoom, pan, lens exposure level, macro mode, shutter time, may be controlled prior to using the camera to capture an image. Further, the intensity of the lights 160a-d in the vehicle documentation booth 120 may be controlled based on light intensity level measured by the light sensors.

The analysis logic 306 may process the commands 224 received at the communication interfaces 302 using the analysis instructions 320. The analysis logic 304 may, in turn, command the sensors via the sensor interfaces according to the commands 224. The analysis logic 304 may include circuitry and software. In one implementation, the analysis logic 304 includes one or more processors 316 and memories 318. The memory 318 may store the analysis instructions 320 (e.g., program instructions) for execution by the processor 316. The memory 318 may also hold the information received at the communication interface 302, and information captured at the sensor interfaces 308.

Vehicles images captured by the camera 312 may further be processed under optical character recognition (OCR) protocols, or other known image recognition protocols, described by the analysis logic 306. The OCR protocols may be utilized to extract vehicle identification information (e.g., VIN) depicted in the captured vehicle images. Once extracted, the vehicle identification information may be transmitted to the vehicle information server 180 for further processing, as described herein. In addition or alternatively, the captured vehicle images may be transmitted directly to the vehicle information server 180, where the vehicle information server 180 may apply the OCR, or other image recognition protocols, to extract the vehicle identification information depicted in the received vehicle images.

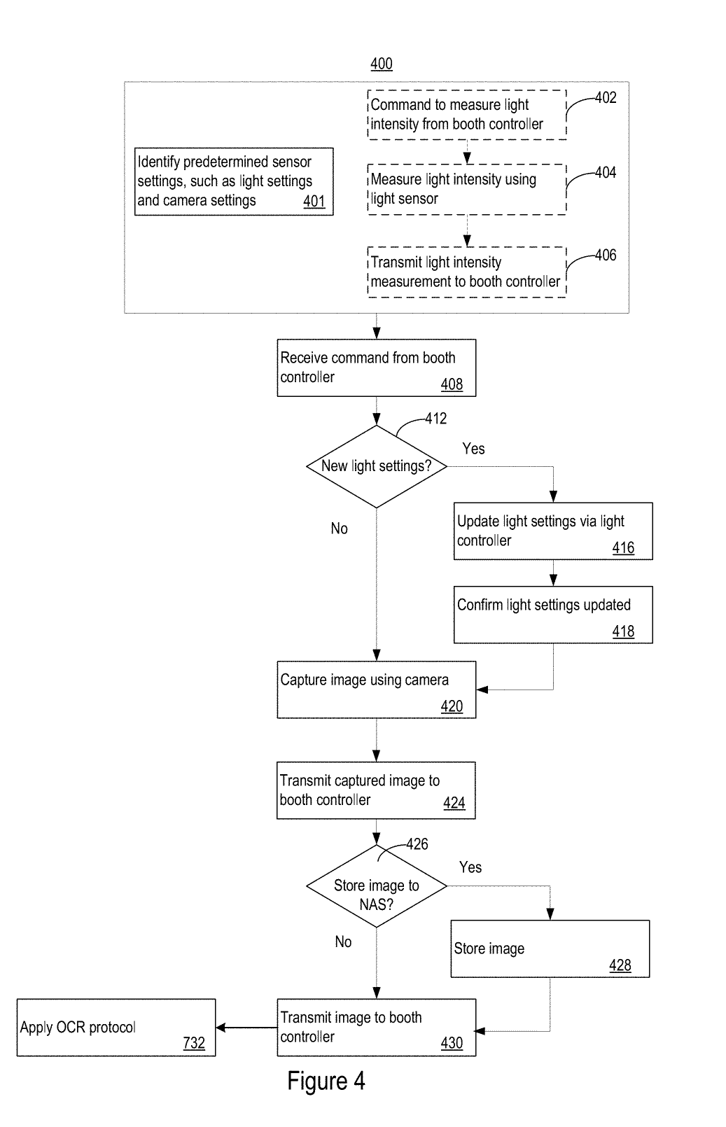

FIG. 4 shows an exemplary flow diagram of logic 400 implemented by a sensor system, such as sensor system 300, for obtaining vehicle identification information. For example, the sensor system 300 may identify predetermined settings for the sensor system 300 and control camera positions and/or camera settings according to the predetermined settings (401). The predetermined settings may be based on user-defined inputs such as size of a vehicle in the vehicle documentation booth 120. For example, light settings may be based on a size of the vehicle being entered by an operator of the booth controller 130. In one implementation, the operator selects a size from a user interface, such as a compact size, sedan size, full-size size or any other indication of size of the vehicle. Thus, the system may preprogram the lights per shot based on size of the vehicle and orientation of the camera being used to capture the image in an enclosed and controlled environment within the vehicle documentation booth 120.

The predetermined settings may also include predetermined camera profiles that describe camera positions and/or camera settings based on the determined vehicle size. By adjusting the camera positions and/or camera settings to account for the determined vehicle size, the sensor system 300 may be optimized for capturing a targeted area, such as the front windshield area that includes a view of the vehicle's VIN.

The predetermined settings may also include settings for other sensor systems equipped in the booth, such as a camera. The predetermined settings identified may be based on a controlled environment within the vehicle documentation booth 120, such as a controlled, and hence known, ambient light intensity, sound level, and other conditions within the vehicle documentation booth 120 that may affect the sensor systems in the vehicle documentation booth 120.

Alternatively, or in addition, in an example, the sensor system 300 may receive a command from the booth controller 130 to actively monitor conditions in the vehicle documentation booth 120 (402). The command may be to measure the light intensity at a particular orientation of the vehicle in the vehicle documentation booth 120. The light intensity may be metered, or measured by the camera sensor systems or by separate light sensor systems. The camera sensor systems may adjust shutter speeds based on measured light intensity. The particular orientation to measure light conditions may depend on the location of the sensor system 300. For instance, in case the sensor system is the front sensor system 140F, the connected light sensor 310 may be used to measure the intensity of light that may affect an image captured by the camera 312 connected to the sensor system 300. In response to the command, the light intensity information may be measured and communicated to the booth controller 130 (404, 406). Lighting the entire vehicle documentation booth 120 indiscriminately with static lighting is not conducive to good photography and other sensor measurements. Extra light causes glare on the vehicle and backlighting conditions. Thereby, the vehicle may not be seen as the subject of the image by being the brightest lighted subject in the image. This issue may be addressed by individual control of each light in the vehicle documentation booth 120.

A vehicle size may also be determined based on the monitored conditions in the vehicle documentation booth 120 (402). For example, a position sensor may obtain vehicle dimension information, where the vehicle dimension information may be referenced to determine the vehicle size. Weight sensors may obtain vehicle weight information, where the vehicle weight information may be referenced to determine the vehicle size. A predetermined camera profile that describes camera positions and/or camera settings may then be selected based on the determined vehicle size. By adjusting the camera positions and/or camera settings to account for the determined vehicle size, the sensor system 300 may be optimized for capturing a targeted area, such as the front windshield area that includes a view of the vehicle's VIN.

In response to receiving the light intensity measurement, the booth controller 130 may transmit a second command to the sensor system 300 (408). The second command may be to capture an image of the vehicle. However, based on the measured, and/or known light intensity, the booth controller 130 may command the sensor system 300 to update the light settings to a set of light setting values provided as part of the second command. The new light settings may be provided to adjust the light intensity at the particular orientation of the vehicle and the camera 312 so as to minimize image artifacts such as reflection, bright spots, and any other such image artifacts. In case new light settings are detected (412) in the received second command, the sensor system 300 may in turn command the light controller 150 to adjust intensity of one or more lights 160 located within the vehicle documentation booth 120 (416). The update light settings may be confirmed (418). For example, in case the vehicle documentation booth 120 is equipped with a light sensor system, the light intensity may be measured to determine if the lights have been adjusted as per the specified settings.

Upon confirmation of the light settings, the camera sensors may be instructed or requested via the booth controller 130 to capture an image of the vehicle within the vehicle documentation booth 120. In an example, the booth controller may send a web service request to the camera sensor system, which may be a webserver, to receive an image. In response, the camera sensor system may capture an image of the vehicle (420). The camera sensor system may be sent a set of predetermined settings such as digital zoom setting, shutter speed setting, or any other setting which may be one of the predetermined settings. The camera sensor system may provide the captured image to the booth controller 130 (424), where the captured image may be a low resolution version. Once received, the booth controller 130 may determine whether to store the captured image in, for example, the NAS 108 (426). When the booth controller 130 determines the captured image will be stored in the NAS 108, the booth controller 130 may send an instruction to the camera sensor system to store the captured image, where the captured image stored in the NAS 108 may be a high-resolution version (428). When the captured image is not stored in the NAS 108, the captured image may be transmitted to the booth controller 130 for further review and analysis, where the transmitted image may be a low resolution version of the captured image (430). For example, the captured image may be reviewed manually by an operator of the booth controller 130. Alternatively, or in addition, the image may be reviewed automatically for settings such as brightness, contrast, or any other image settings such as by using histogram analysis, or other image processing techniques. In response to the command from the booth controller 130, a high resolution image may be stored in the NAS 108 (426).

After receiving the captured image, the booth controller 130 may apply an OCR process, or other image recognition process, to the captured vehicle image to extract vehicle identification information depicted in the captured vehicle image (432). The vehicle identification information may then be transmitted to the vehicle information server 180 to retrieve a vehicle profile matching the vehicle identification information. According to some embodiments, the booth controller 130 may transmit the captured vehicle image to the vehicle information server 180 so that the vehicle information server 180 may apply an OCR process, or other image recognition process, to the captured vehicle image and extract vehicle identification information depicted in the captured vehicle image (432). The vehicle information server 180 may then retrieve the vehicle profile matching the extracted vehicle identification information, and transmit the vehicle profile back to the booth controller 130.

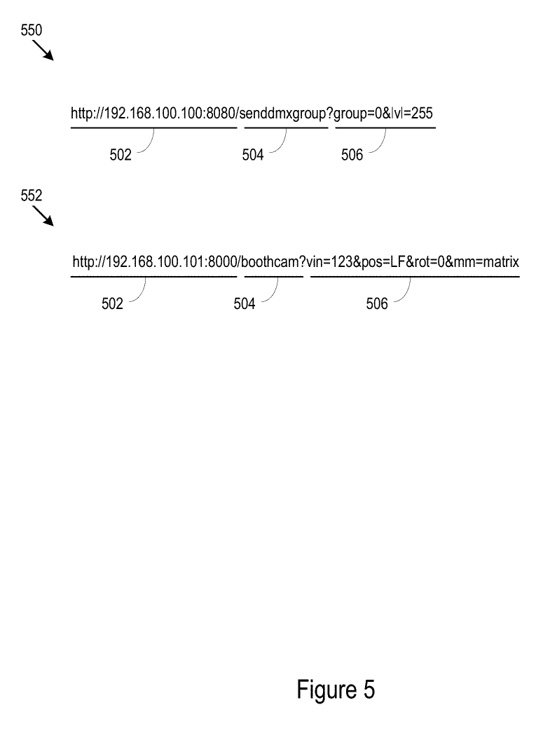

FIG. 5 shows exemplary commands that may be transmitted in the vehicle documentation system 100. As will be evident by description throughout the document, the booth controller 130 may be a mobile device in communication with the components of the vehicle documentation system via a wireless medium. The booth controller 130 effectively communicates control information to sensor systems included in the vehicle documentation system 100, and in response receives the resulting measurements sensed by the sensor systems. For example, in case of the camera sensor systems, the booth controller 130 may execute an HTML document which in turn may request an image from a camera sensor system prompting the camera sensor system to acquire an image. The acquired image may be stored at a resolution the image is captured in and a lower resolution thumbnail image may be transmitted to the booth controller 130. Therefore, lower bandwidth may be required, permitting use of the wireless communication.

The command, such as command 550, may be generated by the booth controller 130. A command may include a unique identifier 502 of the destination device, such as a uniform resource locator (URL), or an Internet Protocol (IP) address and a port address, so that the command is routed to the intended device. For example, the command 550 indicates the IP address and port of the light controller 150 (see FIG. 1), while the command 552 is intended for the sensor system 140L1 (see FIG. 1). The command may further include a function 504 to be executed by the destination device. The function 504 may be part of an Application Programming Interface (API) provided by the destination device. Alternatively, the function 504 may be a custom function programmed for execution by the destination device. Example commands may further include a set of parameters 506 to be used during the execution of the function 504. The parameters 506 may be used for various purposes. For example, the parameters may indicate new setting values. Alternatively, or in addition, the parameters may provide information, such as filenames, date, time or any other information to be used by the destination device when storing results of the operation. The parameters 506 may further indicate information to annotate the results of the operation. Further yet, the parameters 506 may identify devices to which the command is to be relayed to.

The commands 550 and 552 are explained in detail further. The command 550 is a command intended for the light controller 150 as indicated by the unique identifier 502 (see FIG. 1). The function 504 of the command 550 indicates a function to set a light intensity values of lights in a predetermined group, group #0. Such commands facilitate fine turning of the indicated light for each shot providing better images and reduced glare from unneeded, extra light. The light intensity may be adjusted by configuring individual lights or a predetermined group of lights. The group of lights may be defined and adjusted for an image to be captured by a particular sensor system. For example, when capturing an image using the camera 312 of the sensor system 140F which is facing the front of the vehicle, the lights 160a facing that direction may be set to lower intensity and the lights in another direction, such as the lights 160b and 160d facing the vehicle from the left and right sides respectively may be set at a high intensity and the lights 160c facing the rear may be set at a medium intensity. The light intensities may be decided based on the measurement from the light sensor which may indicate ambient light in the vehicle documentation booth 120. Further, lights within each of those groups may be set to different intensities, so as to have a particular light intensity from the group as a whole. It will be understood that other configurations of light groups and intensities of the lights may be possible. In the example command 550, the group 0 as a whole is set to an intensity level 255.

The example command 552 is a command intended for the sensor system 140L1 as indicated by the unique identifier 502. (see FIG. 1). The function 504 of the command 552 indicates an adjustment being made to a camera in the booth. The parameters 506 in this case provide the camera to be adjusted (pos=LF), positioning and orientation of the camera (rot=0), and the light settings to use for this camera (mm=matrix). While two exemplary commands are illustrated, it will be understood that various other commands are possible. Table 1 below provides additional example parameters that may be provided.

TABLE 1

| Meter Mode to change by camera location for lights. | | |
|---|---|---|
| ‘spot’, | //img0 All Lights Off | |
| ‘spot’, | //img1 Front Lights On | |
| ‘spot’, | //img2 Left Lights On | |
| ‘matrix’, | //img3 Left Front Camera | |
| ‘matrix’, | //img4 Left Front Wheel Camera | |
| ‘spot’, | //img5 Rear Lights On | |
| ‘spot’, | //img6 Front Lights Off | |
| ‘matrix’, | //img7 Left Rear Wheel Camera | |
| ‘matrix’, | //img8 Left Rear Camera | |
| ‘spot’, | //img9 Left Lights Off | |
| ‘spot’, | //img10 | Rear Half Lights On |
| ‘spot’, | //img11 | Rear Camera |
| ‘spot’, | //img12 | Rear Half Lights Off |
| ‘spot’, | //img13 | Rear Lights On |
| ‘spot’, | //img14 | Right Lights On |
| ‘matrix’, | //img15 | Right Rear Camera |
| ‘matrix’, | //img16 | Right Rear Wheel Camera |
| ‘spot’, | //img17 | Front Lights On |
| ‘spot’, | //img18 Rear | Lights Off |
| ‘matrix’, | //img19 | Right Front Wheel Camera |
| ‘matrix’, | //img20 | Right Front Camera |
| ‘spot’, | //img21 | Left Lights Off |
| ‘spot’, | //img22 | Front Half Lights On |
| ‘matrix’, | //img23 | Front Camera |
| ‘spot’, | //img24 | All Lights On |
| ‘spot’]; | //img25 | Top Camera |

Table 2 below provides example settings of groups of lights corresponding to particular image orientations.

TABLE 2

| var camHosts = [ | | |
|---|---|---|
| ‘DMX’, | //img0 | All Lights Off |
| ‘DMX’, | //img1 | Front Lights On |
| ‘DMX’, | //img2 | Left Lights On |
| ‘192.168.100.101:8000’, | //img3 | Left Front Camera |
| ‘192.168.100.102:8000’, | //img4 | Left Front Wheel Camera |
| ‘DMX’, | //img5 | Rear Lights On |
| ‘DMX’, | //img6 | Front Lights Off |
| ‘192.168.100.103:8000’, | //img7 | Left Rear Wheel Camera |
| ‘192.168.100.104:8000’, | //img8 | Left Rear Camera |
| ‘DMX’, | //img9 | Left Lights Off |
| ‘DMX’, | //img10 | Rear Half Lights On |
| ‘192.168.100.105:8000’, | //img11 | Rear Camera |
| ‘DMX’, | //img12 | Rear Half Lights Off |
| ‘DMX’, | //img13 | Rear Lights On |
| ‘DMX’, | //img14 | Right Lights On |
| ‘192.168.100.106:8000’, | //img15 | Right Rear Camera |
| ‘192.168.100.107:8000’, | //img16 | Right Rear Wheel Camera |
| ‘DMX’, | //img17 | Front Lights On |
| ‘DMX’, | //img18 | Rear Lights Off |
| ‘192.168.100.108:8000’, | //img19 | Right Front Wheel Camera |
| ‘192.168.100.109:8000’, | //img20 | Right Front Camera |
| ‘DMX’, | //img21 | Right Lights Off |
| ‘DMX’, | //img22 | Front Half Lights On |
| ‘192.168.100.110:8000’, | //img23 | Front Camera |
| ‘DMX’, | //img24 | All Lights On |
| ‘192.168.100.111:8000’]; | //img25 | Top Camera |

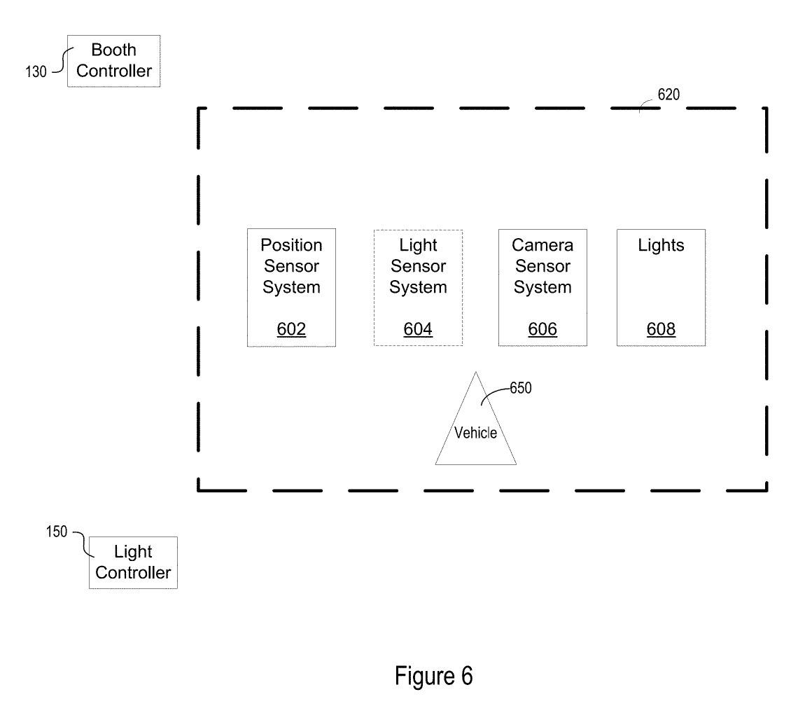

In another example, the booth controller 130 may command various different sensor systems to generate documentation for a vehicle in the vehicle documentation booth 120. FIG. 6 shows an example vehicle documentation booth 620, that may be a representation of vehicle documentation booth 120 according to some embodiments. The vehicle documentation booth 620 includes various sensor systems such as position sensor system 602, light sensor system 604, camera sensor system 606. The vehicle documentation booth 620 may include additional sensor systems, such as microphones, vibration sensors, temperature sensors, ultrasonic sensors and other measuring devices. The vehicle documentation booth 620 further may include lights 608, controllable via the light controller 150. The booth controller 130 may manage operations of the various sensor systems and lights to generate documentation of a vehicle 650 positioned within the vehicle documentation booth 620.

The sensor systems of the vehicle documentation booth 620 (position sensor system 602, light sensor system 604, and/or camera sensor system 606) may include circuitry similar to that described with respect to the sensor system 300. The sensor systems of the vehicle documentation booth 620 may be webservers that receive a command or request from the booth controller 130. In response, the sensor systems of the vehicle documentation booth 620 may capture information via the sensors equipped on the sensor systems of the vehicle documentation booth 620 and transmit the captured information to the booth controller 130. The different sensor systems of the vehicle documentation booth 620 may be equipped with different sensors to capture different types of information. Alternatively, the sensor systems of the vehicle documentation booth 620 may all be equipped with a set of sensors out of which a subset is utilized. For example, the position sensor system 602 may be equipped, or may use, position sensors. The position sensors may use infrared, ultrasonic, weight, temperature or other such physical characteristics to determine position of the vehicle 650. The light sensor system 604 may be equipped with, or may use, light sensors that measure intensity of light within the vehicle documentation booth 620. The light intensity measured may be the ambient light in the vehicle documentation booth 620.

The camera sensor system 606 may be equipped with a still image or a video capture camera. According to some embodiments, the camera may be attached to an unmanned aerial vehicle (UAV) such as a copter-type drone device. An example of a UAV is disclosed in US Published Application No. 2018/0155057, incorporated by reference herein in its entirety. The UAV is capable of hovering around the vehicle 650 to position the camera to capture images according to image capture instructions received from the booth controller 130. The image capture instructions may be transmitted wirelessly by the booth controller 130 through a network connecting the booth controller 130 and the UAV, such as network 102. The camera may be adjusted by the booth controller 130 and/or the camera sensor system 606. For example, the camera may be adjusted to zoom-in or zoom-out. The zooming may be a digital zoom (sometimes referred to as solid state zoom), an optical zoom, or a combination of both.

For example, the region of an image sensor of the camera sensor system 606 used to capture the vehicle may be adjusted based on the size of the vehicle 650. The size of the vehicle 650 may be input by an operator into the booth controller 130. Alternatively, the size of the vehicle 650 may be determined by the booth controller 130 based on sensor information detected by a sensor included in the position sensor system 602, the light sensor system 604, or another sensor configured to sense attributes of the vehicle 650 from which the booth controller 130 is able to determine the size of the vehicle 650. For example, sensors included in the position sensor system 602 and/or the light sensor system 604 may detect dimensional attributes of the vehicle 650 that may be referenced by the booth controller 130 to determine a size of the vehicle 650. A weight sensor (not illustrated) included in the vehicle documentation booth 620 may sense a weight of the vehicle 650 that may be referenced by the booth controller 130 to determine a size of the vehicle 650.

The size of the vehicle 650 may further be determined based on information, such as that obtained from a vehicle information database, given inputs (e.g., a VIN), for example, that identify the make/model of the vehicle 650. The vehicle information (e.g., VIN) may be input by an operator into the booth controller 130, or the vehicle information may be obtained by applying image recognition on vehicle images and identifying the vehicle information (e.g., VIN) from the vehicle images. The VIN type of vehicle information is a series of alphanumeric characters that are representative of vehicle attribute information such as, for example, vehicle manufacturer make, vehicle model, vehicle model year, vehicle manufacturing plant, vehicle type, and other vehicle attributes. The VIN may be included on top of a front dashboard of the vehicle where it is viewable through the front windshield. The VIN, or other vehicle identification information, may also be found at other locations of the vehicle that may be captured by a camera of the camera sensor system 606.

So when the vehicle is identified as a sedan based on vehicle information received by the booth controller 130, the booth controller 130 may further determine that the vehicle is medium sized. When the vehicle is identified as a minivan or SUV based on vehicle information received by the booth controller 130, the booth controller 130 may further determine that the vehicle may be considered large sized. The amount of the image sensor used to obtain the vehicle image may then be controlled to vary according to the determined vehicle size, with larger vehicles using larger extents of the image sensor.

For example, when the vehicle 650 is determined to be a small vehicle, a smaller region of the image sensor may be utilized to capture the image of the vehicle 650, while a larger region of the image sensor may be utilized when the vehicle 650 is determined to be a large vehicle. Additionally, or alternatively, the camera may be adjusted to pan in specific direction. A flash function on the camera may also be adjusted. Further, the camera may be adjusted to change lens exposure level, shutter speed, and any other such settings.

The booth controller 130 may also adjust the lights 608 by altering the intensity settings, such as to dim or brighten the lights. The light controller 150 may also be a webserver able to receive commands from the booth controller or the sensor systems. The commands to the light controller may indicate adjustment to be made to the lights 608, such as turning a light, or a group of lights on or off, or adjusting brightness of a light or a group of lights, or flashing the lights on and off.

The lights 608 may be divided into various groups. An individual light may be part of one or more groups. Each light may be assigned a unique identifier. Further, each group may also be assigned a unique identifier. The booth controller 130 or the sensor systems may provide settings to be applied to a light or a group of lights by indicating the corresponding identifier and the settings to be applied, such as in command 550 of FIG. 5. The groups of lights may be defined such that each group of lights is used when capturing information from a particular orientation.

The vehicle 650 may be an automobile, such as a car, sports utility vehicle (SUV), mini-van, truck, motorcycle, or any other automobile. The vehicle 650 may also be a boat, an airplane, or any other vehicle. The booth controller 130 may identify the vehicle based on an identifier of the vehicle, such as the VIN. The booth controller 130 may request information of the vehicle from a database. The database may be in the NAS 108, or on a server that is part of the network 102. The database may provide information such as vehicle make, model, year of manufacture, history of sales, odometer reading, interior conditioning, and any other details of the vehicle. The details may also provide whether the vehicle has air conditioning, leather seats, navigation, and/or other features of the vehicle.

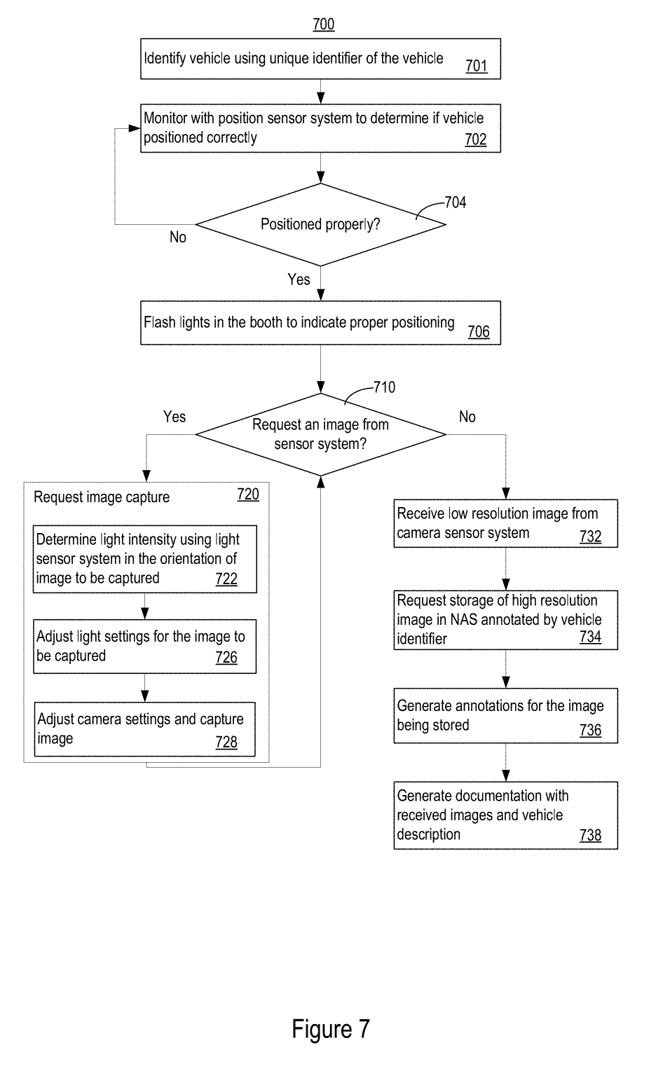

FIG. 7 shows an exemplary flow diagram of logic 700 for a vehicle documentation system (e.g., vehicle documentation system 100) to implement a vehicle documentation generation process. The process may be performed by the booth controller 130.

The booth controller 130 may obtain vehicle identification information based on a vehicle identifier (e.g., VIN) corresponding to the vehicle 650 positioned within the vehicle documentation booth 620 (701). The vehicle identifier may be manually entered by an operator into a graphical user interface (GUI) of the booth controller 130. In addition or alternatively, the vehicle identifier may include a barcode that may be scanned using a scanner, such as a barcode scanner, or a camera. The scanner may be equipped on the booth controller 130. In addition or alternatively, the vehicle identifier may be obtained according to the process described by the flow diagram of logic 400 for obtaining vehicle identification information.

As part of identifying the vehicle (701), according to some embodiments the booth controller 130 may transmit the vehicle identifier to the vehicle information server 180 to retrieve a vehicle profile as described by the flow diagram of logic 400 for obtaining vehicle identification information. In addition or alternatively, when the NAS 108 is configured to store vehicle profiles, the booth controller 130 may obtain a matching vehicle profile based on the vehicle identifier by parsing the NAS 108 for the matching vehicle profile.

The vehicle profile may indicate a size of the vehicle. For example, the size may be provided as length, width, and height dimensions of the vehicle. Alternatively, the size may be provided as a size-category, such as a small, medium, large, extra-large. In another example, the size may be provided as a category of the vehicle itself, such as a compact, sedan, mid-size, full-size, SUV, cross-over, truck, or other such vehicle category.

Based on the identified size of the vehicle 650, the booth controller 130 may determine a position within the vehicle documentation booth 620 at which the vehicle 650 should be placed to capture other information of the vehicle, such as images of the vehicle. When the camera sensor system 606 is in a fixed position within the vehicle documentation booth 120, and the vehicle 650 is movable, depending on where the vehicle 650 is positioned it may or may not be aligned in the image. So an accurate method of providing feedback to an operator for positioning the vehicle 650 may be provided to provide instructions to the operator to position the car appropriately within the vehicle documentation booth 120 based on the identified size of the vehicle that will allow the camera sensor system 606 to capture the appropriate images. When the camera sensor system 606 includes movable components for moving the positioning of cameras included in the camera sensor system 606, the booth controller 130 may control the positioning of the cameras based on the identified size of the vehicle 650 to allow the camera sensor system 606 to capture appropriate images.

The booth controller 130 may determine specific target locations on the vehicle 650 to capture in an appropriate image based on vehicle information included in the vehicle profile. For example, the booth controller 130 may recognize a target location on the vehicle 650 that is listed in the vehicle profile (e.g., the vehicle profile may have a section describing one or more target locations such as a front bumper, a rear bumper, and front hood that are known to have a high likelihood of including damage). The booth controller 130 may also interpret vehicle history information from the vehicle profile and determine one or more target locations for capturing images on the vehicle 650 based on the vehicle history information (e.g., hail damage report described in the vehicle profile may be interpreted by the booth controller 130 to determine a front hood, front windshield, or other vehicle locations known to be damaged during hail storm as a target location for capturing images; a rear end collision accident report may be interpreted by the booth controller 130 to determine a rear bumper, rear frame, air bag, or other vehicle locations known to be damaged during a rear end collision as a target location for capturing images). The booth controller 130 may also interpret vehicle build report information from the vehicle profile and determine one or more vehicle features that are identified in the vehicle build report for capturing images on the vehicle 650 based on the vehicle build report information (e.g., when the vehicle build report information describes the vehicle 650 as being built with upgraded wheels, the booth controller 130 may interpret this vehicle build report information to determine the vehicle wheels as a target location for capturing images to confirm the upgraded wheels are still installed). This way, target locations on the vehicle 650 may include areas on the vehicle 650 identified as being damaged (e.g., driver side door, passenger side door, front bumper, rear bumper), involved in an accident (e.g., front end collision), or including a vehicle feature that should be verified (e.g., premium wheels).

The booth controller 130 may monitor the position of the vehicle 650 within the vehicle documentation booth 620 to ensure target locations on the vehicle 650 that have been determined based on the vehicle profile will be captured into appropriate images (702). The booth controller 130 may prompt the operator to reposition the vehicle so that cameras of the camera sensor system 606 will be positioned to capture the appropriate images. The prompt may be in the form of audible commands output from speakers that are controlled by the booth controller 130, written commands output from a printer controlled by the booth controller 130, or displayed on a display screen controlled by the booth controller 130 (e.g., “lift up carpet to search for water damage” or “inspect lower portion of passenger side door”).

In addition or alternatively, the booth controller 130 may prompt the operator to manually take images of target locations determined from the vehicle profile that are not able to be captured by the cameras of the camera sensor system 606 (e.g., a prompt may ask the operator to “Look at carpets for flood damage” when the vehicle profile indicates the vehicle 650 has been involved in a flood). The operator prompt may be in the form of a display on the GUI displayed on the booth controller 130, an audible prompt output via speakers on the booth controller 130, or written instructions that are printed as part of a report generated by the booth controller 130.

In addition or alternatively, the booth controller 130 may control the camera sensor system 606 to adjust camera positions and/or camera settings to ensure the cameras will capture the target locations determined from the vehicle profile. When cameras of the camera sensor system 606 are attached to the UAV, the booth controller 130 may transmit image capture instructions for capturing the target locations to the UAV.

The booth controller 130 may continuously receive position information of the vehicle 650 from the position sensor system 602 for such monitoring. Position information from the camera sensor system 606 may also be received that identifies camera positions for cameras included in the camera sensor system 606. The position information may be received in response to the booth controller 130 requesting such information from the position sensor system 602.

The booth controller 130 may compare the received position information of the vehicle 650 and/or camera sensor system 606 to determine whether the positioning of the vehicle 650 and/or camera sensor system 606 allows for the capturing of images of the target locations on the vehicle 650 (704).

When the vehicle 650 and/or camera sensor system 606 are determined to be positioned such that image capture of the target locations on the vehicle 650 is made difficult, not possible, or the vehicle 650 has not been positioned correctly, the operator may be prompted to move the vehicle 650 and/or move specified components or parts of the vehicle (e.g., “lift up carpet to search for water damage”), the operator may be prompted to move cameras of the camera sensor system 606, and/or the booth controller 130 may control positioning of the cameras in the camera sensor system such that the target locations on the vehicle 650 may be captured (702).

Once the vehicle 650 and/or the camera sensor system 606 are substantially in the determined position for capturing the target locations on the vehicle 650, the booth controller 130 may provide an indication that the determined positioning is achieved. For example, the booth controller 130 may send commands for the light controller 150 to flash some or all of the lights 608 within the vehicle documentation booth 620 (706).

The booth controller 130 may then determine what information of the vehicle 650 is to be captured using the various sensor systems within the vehicle documentation booth 620. For example, images of the vehicle 650 from various angles that correspond to the target locations may be captured to further document the vehicle 650. Such information may be used to generate vehicle documentation that may be useful for sharing with potential bidders or customers who may be interested in purchasing the vehicle 650. If an image is required, a request to capture the image from the particular viewpoint may be sent to the camera sensor system 606 (710, 720). Capturing the image may involve various steps in itself (720). For example, initially, intensity or brightness of the ambient light in the vehicle documentation booth 620 may be determined (722). The ambient light may be measured for capturing the image from a particular vantage point, or angle, or orientation of the vehicle 650 (722). For example, a front view of the vehicle 650 may be captured. The front view may be captured with or without the vehicle hood opened. Other angles and orientations may be possible such as a side view from the driver's side or from the passenger's side; rear view; top view; interior view; or any other view of the vehicle to illustrate features of the vehicle to the potential bidders or customers.

The booth controller 130 may determine optimal light intensity or brightness to capture a presentable image of the vehicle 650 from the particular vantage point. The actual light intensity may be measured using the light sensor system 604 (722). The actual light intensity may be compared with the calculated optimal light intensity and accordingly, settings for the lights 608 may be calculated. The calculated settings may be applied to the lights 608 so that the optimal light intensity is achieved in the vehicle documentation booth 620 (726). The calculated settings may be applied using the light controller 150. The booth controller 130 or the camera sensor system 606 may be responsible for calculate the updated settings and request the light controller 150 to apply the updated settings. As described herein, the light settings may involve updating individual lights or group of lights.

Further, the booth controller 130 may determine settings of the camera sensor system from the particular vantage point from which an image is to be captured based on the vehicle size, the light intensity, and other parameters (726). Once the light settings and camera settings are updated, the camera sensor system 606 may capture an image of the vehicle 650 from the specified vantage point (728). The booth controller 130 may send a request to the camera sensor system 606 to capture the image once the settings have been updated. Further, the booth controller 130 may send multiple requests to the camera sensor system 606 to capture multiple images from the particular vantage point. The multiple images may be captured using the different combinations of the light and/or camera settings. This provides multiple images of the target locations on the vehicle 650 in case one or more of the images are not usable (e.g., image distortion, shadows, or other objects or image deficiencies that prevent the target location from being clearly depicted in a captured image). For example, multiple images from the particular vantage point with same light settings but different camera settings may be captured. For instance, an image from the camera sensor system 606 positioned close to the left front of the vehicle 650 may be used to capture an image of the entire vehicle 650 as well as an image that provides details of the left front tire of the vehicle 650. Alternatively, or in addition, the light settings may also be changed for the two images captured. Images other than those described as examples in this document may be captured.

The fixed camera sensor system 606 in the vehicle documentation booth 120 may capture exterior images of the vehicle 650. Interior shots of the vehicle 650 may be captured by using the booth controller 130, which is a mobile device. The booth controller 130 may be equipped with an onboard camera that may be controlled by an application interfaced with the vehicle documentation generation system. In addition, other mobile cameras that may be re-positioned and are part of the camera sensor system 606 may be controlled by the booth controller 130 to capture the interior images, this may include any UAVs that are part of the camera sensor system 606. The interior images may be captured as part of the workflow of controlling the documentation booth 120 (728). The interior images may then be integrated into the set of images captured from the camera sensor system 606.

The image captured by the camera sensor system 606 may be stored at a resolution at which the image is captured, such as 2 Mega Pixel (MP), 5 MP, 13 MP, or any other resolution the camera may be set for. However, the image may be converted to a lower resolution image, such as a thumbnail image, or 640×480, or any other resolution. The lower resolution image may be forwarded to the booth controller 130. The booth controller 130 may receive and display the lower resolution image (732). An operator may view the displayed lower resolution image on a display of the booth controller 130 and determine whether the image needs to be retaken. For example, the image may be too noisy, or there may be a reflection, or the image may be distorted. If the image is retaken, the earlier image may be replaced by the retaken image. Alternatively, the retaken image may be stored in addition to the earlier image. According to some embodiments, the booth controller 130 may apply image quality tests on the captured image to determine whether the captured image satisfies predetermined image quality tests (e.g., tests for brightness levels, noise levels, contrast levels, and other known image quality attributes). When the captured image satisfies the predetermined image quality tests, the booth controller 130 may proceed with further processing (736). When the captured image does not satisfy the predetermined image quality tests, the booth controller 130 may request another image from the camera sensor system 606 (710).

In case the image is acceptable, the booth controller 130 may request the camera sensor system 606 to store the image (734). For example, the booth controller 130 may display various user interface elements, such as an archival directive element. The operator may interact with the user interface elements to send requests to the sensor systems and/or light controller 150. For example, the archival directive element may send a request to the camera sensor system 606 to store the image at a high resolution, such as the resolution at which the image was taken. Alternatively, the booth controller 130 may send a command that indicates a resolution at which the image is to be stored. The resolution may be one of the parameters in the command sent, such as the commands 550 and 552. Alternatively, the resolution may be a predetermined resolution that has been communicated to the camera sensor system 606 previously. Alternatively, or in addition, the command or request sent by the booth controller 130 may contain a destination to store the image. The destination may be the NAS 108. The destination may further specify details such as a folder within the NAS 108. Thus, the captured image may be stored in the specified destination without being first transferred to the booth controller 130.

Further yet, the command or request may include other parameters to indicate annotations for the image being stored, such as the unique identifier of the vehicle 650 to be included in the filename or as a tag at the time the image is stored (736). The camera sensor system 606 may include further annotations to the filename or as tags to the image. For example, the camera sensor system 606 may include orientation, such as ‘left front’ or ‘left front tire’, when storing the image. Other annotations may also be possible, such as the settings applied to the camera sensor system and the light settings used when capturing the image. Additionally, the information obtained from the database, indicating features and other information of the vehicle 650 may be used as annotations.

The captured images and the vehicle profile information may be put together to generate documentation of the vehicle 650 (738). The documentation may be in form of a web-page, document, tabular display, worksheet, database table, or any other format. For example, a webpage, such as a Hyper Text Markup Language (HTML) page, may be generated with the images and the information rendered on the webpage. It is understood that HTML is just one possible example format and other formats such as Extensible Markup Language (XML), Portable Document Format (PDF), Open Document Format (ODF), or any other proprietary or non-proprietary formats may be used to generate the documentation. The generated documentation may be static or dynamic in nature. Static documentation is non-interactive, whereas dynamic documentation may be more interactive in nature. For example, the images displayed in the documentation may be thumbnail images, and when interacted with, such as by clicking, may display the corresponding higher resolution image. Alternatively, or in addition, the interaction may display vehicle details pertaining to the image that is being viewed in detail.

The generated documentation may be presented to the potential bidders and customers to review the vehicle information so as to determine whether to pursue a sale of the vehicle. The generated documentation may be integrated with a web-portal of a seller or auctioneer of the vehicle. Thus, upon entry of the vehicle into the vehicle documentation booth, with a few interactions with the booth controller, the seller or auctioneer, may be able to capture images of the vehicle from various angles and vantage points, link the images to the vehicle information in a database and generate documentation, such as a webpage, that may be presented to a potential purchaser as marketing material with the vehicle images and information. The vehicle documentation system described may thus enable or enhance efficiency of operation of a seller or auctioneer, such as a vehicle dealer or auctioneer.

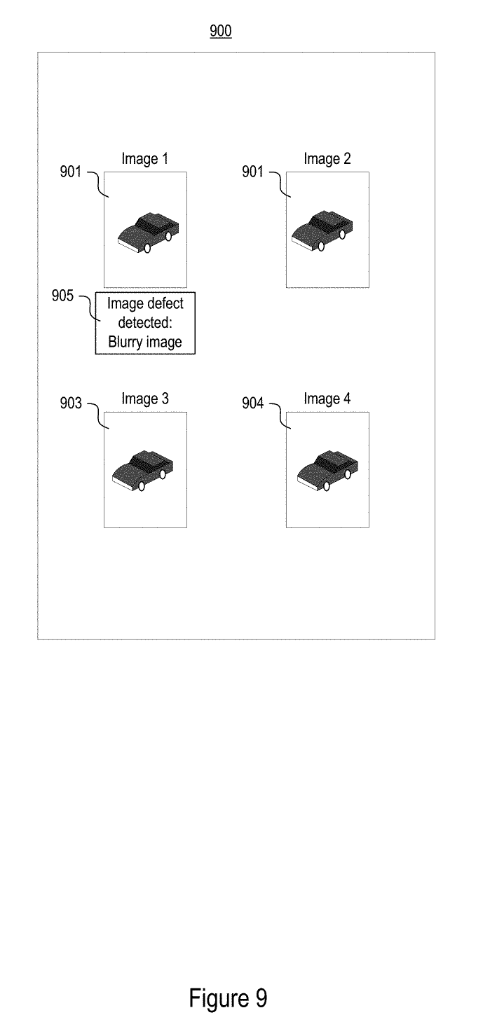

FIG. 9 shows an exemplary graphical user interface (GUI) 900 that may be generated to present at least the received vehicle images. The GUI 900 is shown to include four exemplary vehicle images: first vehicle image 901, second vehicle image 902, third vehicle image 903, and fourth vehicle image 904. Although four exemplary vehicle images are shown, the GUI may be modified to include a fewer, or greater, number of vehicle images. The vehicle images may depict an interior shot of the vehicle including one or more interior components, an exterior shot of the vehicle including one or more exterior components, or a shot of the vehicle's VIN. The GUI 900 may be part of a web-based application running on a web server and being displayed on a user's mobile computing device. The GUI 900 may also be part of a website running on a web server and being displayed through a web-browser application running on a user's mobile computing device.

When an image defect is detected by the application running the GUI 900, a visual indicator 905 may be presented on the GUI 900 identifying the defect. The visual indicator 905 may be a written message, or color coded flag. The visual indicator 905 may also specifically identify the image defect (e.g., blurry image). The image defect may relate to an image quality defect (e.g., blurry image), or an image content defect (e.g., vehicle VIN is cut off).

In response to detecting the image defect, the application may, for example, activate an option for retaking the first vehicle image 901 that has been recognized as having the defect. According to embodiments where the application displaying the GUI 900 is running on a computing device including a digital camera, the application may automatically commence an image capturing process that opens up a camera view and options for capturing a new image to replace the first vehicle image 901. Alternatively, the image capturing process may be commence based on a user input such as a tap touch input over the first vehicle image 901. The new vehicle image captured by the digital camera may then replace the previous image having the defects as the first vehicle image 901.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A vehicle documentation booth comprising:
a structure adapted to receive a vehicle;
multiple sensor systems distributed within the structure, including a camera system comprising:
a camera system communication interface configured to receive control commands; and
an image capturing device configured to capture images based on received control commands; and
a booth controller comprising:
a booth communication interface configured to communicate with the camera system communication interface and a web server; and
booth controller circuitry in communication with the booth communication interface, the booth controller circuitry configured to:
responsive to transmission of vehicle identification information being transmitted to the web server, receive, through the booth communication interface, a vehicle report, the vehicle report comprising one or more aspects of the vehicle;
generate an image capturing control command based on the one or more aspects of the vehicle; and
control the booth communication interface to communicate the image capturing control command to the camera system communication interface in order to modify operation of the image capturing device.

2. The vehicle documentation booth of claim 1, wherein the booth controller circuitry is further configured to:
receive the vehicle identification information via the image capturing device; and
control the booth communication interface to transmit a vehicle report request to the web server, wherein the vehicle report request includes the vehicle identification information,
wherein responsive to transmission of the vehicle report request, the booth controller circuitry is configured to receive the vehicle report;
wherein the booth controller circuitry is further configured to determine a vehicle history item for capturing in an image based on the vehicle report; and
wherein the image capturing control command identifies the vehicle history item.

3. The vehicle documentation booth of claim 2, wherein the vehicle history item identifies a vehicle component installed on the vehicle, and the image capturing control command includes a command to capture an image of the vehicle component.

4. The vehicle documentation booth of claim 3, wherein the camera system is configured to:
receive the image capturing control command, through the camera system communication interface;
position the image capturing device to a location within the vehicle documentation booth for capturing the image of the vehicle component; and
control the image capturing device to capture the image of the vehicle component.

5. The vehicle documentation booth of claim 4, wherein the booth controller circuitry is further configured to:
generate a booth document that includes the vehicle report and the image of the vehicle component.

6. The vehicle documentation booth of claim 2, wherein the vehicle history item identifies a vehicle component installed on the vehicle; and
wherein the booth controller circuitry is further configured to:
generate a booth document that includes the vehicle report and instructions for capturing an image of the vehicle component.

7. The vehicle documentation booth of claim 1, wherein the vehicle report comprises an indication of vehicle specifications; and
wherein the booth controller circuitry is configured to generate the image capturing control command based on the indication of the vehicle specifications.

8. The vehicle documentation booth of claim 1, wherein the image capturing device is installed on an unmanned aerial vehicle;
wherein the booth controller circuitry is further configured to:
receive the vehicle identification information obtained by the image capturing device on the unmanned aerial vehicle; and
transmit a vehicle report request to the web server, the vehicle report request comprising the vehicle identification information;
wherein responsive to transmission of the vehicle report request, the booth controller circuitry is configured to receive the vehicle report.

9. The vehicle documentation booth of claim 1, wherein the camera system further comprises an illumination source to provide lighting for the image capturing device;
wherein the vehicle report includes a vehicle history item identifying a vehicle component installed on the vehicle; and
wherein the booth controller circuitry is further configured to:
generate a lighting control command for controlling the illumination source to provide light to the vehicle component; and
communicating the lighting control command to the illumination source.

10. The vehicle documentation booth of claim 1, wherein the vehicle report identifies at least one of a vehicle build report, a vehicle accident report, or a vehicle transactions report.

11. The vehicle documentation booth of claim 1, wherein the booth controller circuitry is further configured to:
receive an image captured according to the image capturing control command;
determine whether the image satisfies a predetermined image quality criteria;
in response to determining the image satisfies the predetermined image quality criteria, control storage of the image in an image database; and
in response to determining the image does not satisfy the predetermined image quality criteria, control the booth communication interface to re-communicate the image capturing control command to the camera system communication interface.

12. A vehicle documentation booth comprising:
a structure adapted to receive a vehicle;
a position sensor system configured to sense a dimension of the vehicle with reference to the vehicle documentation booth;
a camera system comprising:
a camera system communication interface configured to receive control commands; and
an image capturing device configured to capture images based on received control commands;
a booth controller comprising:
a booth communication interface configured to communicate with the position sensor system;
booth controller circuitry in communication with the booth communication interface, the booth controller circuitry configured to:
receive vehicle dimension information sensed by the position sensor system;
determine whether the image capturing device is positioned to capture a predetermined location on the vehicle based on the vehicle dimension information;
in response to determining the image capturing device is not positioned to capture the predetermined location on the vehicle, control the image capturing device to re-position to a location within the vehicle documentation booth from where the image capturing device has a view to capture the predetermined location on the vehicle;
in response to determining the image capturing device is positioned to capture the predetermined location on the vehicle, generate an image capturing control command to capture the predetermined location on the vehicle; and
control the booth communication interface to communicate the image capturing control command to the camera system communication interface.

13. The vehicle documentation booth of claim 12, wherein the predetermined location on the vehicle includes at least a front windshield of the vehicle.

14. The vehicle documentation booth of claim 12, wherein the camera system is configured to:
receive, through the camera system communication interface, the image capturing control command; and
control the image capturing device to capture the image of the predetermined location on the vehicle based on the image capturing control command.

15. The vehicle documentation booth of claim 14, wherein the captured image of the predetermined location on the vehicle includes a depiction of vehicle identification information corresponding to the vehicle.

16. The vehicle documentation booth of claim 15, wherein the booth controller circuitry is further configured to:
receive, through the camera system communication interface, the captured image;
extract vehicle identification information from the captured image; and
generate an information request for a vehicle report corresponding to the vehicle identification information; and
control the booth communication interface to communicate the information request to a web server.

17. The vehicle documentation booth of claim 16, wherein the booth controller circuitry is further configured to:
receive, through the booth communication interface, vehicle identification information from the web server in response to the information request;
identify a vehicle history item from a vehicle report corresponding to the vehicle identification information; and
generate an image capturing control command based on the vehicle history item.

18. A method for generating a vehicle document related to a vehicle within a vehicle documentation booth, the method comprising:
receiving, through a booth communication interface, vehicle identification information corresponding to the vehicle;
controlling the booth communication interface to transmit a vehicle report request to a web server, wherein the vehicle report request includes the vehicle identification information;
receiving, through the booth communication interface, a vehicle report from the web server in response to the vehicle report request;
determining a targeted vehicle component for capturing in an image based on the vehicle report;
generating an image capturing control command identifying the targeted vehicle component;
controlling the booth communication interface to communicate the image capturing control command to a camera system;
controlling an image capturing device of the camera system to capture an image including a depiction of the targeted vehicle component from the camera system; and
generating the vehicle document including the vehicle report and the captured image.

19. The method of claim 18, further comprising:
receiving, through the booth communication interface, vehicle position information identifying a position of the vehicle within the vehicle documentation booth;
positioning the image capturing device to a location within the vehicle documentation booth for capturing the image of the targeted vehicle component based on the vehicle position information; and
controlling the image capturing device to capture the image of the targeted vehicle component according to the image capturing control command.

20. The method of claim 19, wherein the image capturing device is installed on an unmanned aerial vehicle.
